(19) United States
(12) Patent Application Publication
(10) Pub. No.: US 2005/0107043 A1
(43) Pub. Date: May 19, 2005

(54) Integration of diversity switch in combination with a T/R switch for a radio transceiver on a single chip

(75) Inventors: Madhu Avasarala, Sunnyvale, CA (US); Ahmed Hassan, San Jose, CA (US)

Correspondence Address: CROWELL & MORING LLP;INTELLECTUAL PROPERTY GROUP, P.O. BOX 14300, WASHINGTON, DC, 20044-4300, US

(73) Assignee: Maxim Integrated Products, Inc.

(21) Appl. No.: 10/714,206

(22) Filed: Nov. 13, 2003

(51) Int. Cl. H04B 1/44

(52) U.S. Cl. 455/78; 455/83; 455/277.1

(57) ABSTRACT

A transceiver including a receiver, a transmitter, a first antenna port, a second antenna port, a first switching element to selectively couple the first antenna port to the receiver, a second switching element to selectively couple the second antenna port to the transmitter, and a third switching element to selectively couple the second antenna port to the receiver. The third switching element may be a resonant switch which is configurable as a parallel resonant circuit in a first mode to substantially isolate the second antenna port from the receiver, and configurable as a coupling circuit in a second mode to substantially couple the second antenna port to the receiver.

### FIELD OF THE INVENTION

This invention relates generally to wireless transceivers, and in particular, to an integrated transceiver comprising a first antenna port used for signal transmission and diversity signal reception, a second antenna port used for primary signal reception, and a switching element to selectively isolate the receiver from the transmitter and to selectively couple the first antenna port to the receiver.

### BACKGROUND OF THE INVENTION

A wireless transceiver typically comprises a transmitter section to generate a relatively high power signal for wireless transmission, and a receiver section to receive, amplify, and process a relatively low power signal received from a wireless medium. Often, such transceiver uses a single antenna for both transmitting and receiving of signals. In such architecture, isolation of the receiver section from the relatively high power transmission signal is typically required. This is further explained with reference to the following example.

FIG. 1 illustrates a schematic diagram of an exemplary wireless transceiver system 100. The transceiver system 100 includes a monolithic (integrated) transceiver 110 electrically coupled to an antenna 150. The monolithic transceiver 110, in turn, includes a receiver section represented as a low noise amplifier (LNA) 112 and a transmitter section represented as a power amplifier (PA) 114. The monolithic transceiver 110 further includes a first switching field effect transistor (FET) 116 coupled between an antenna port 120 and the LNA 112, and a second switching FET 118 coupled between the antenna port 120 and the PA 114. In this architecture, the switching FETs 116 and 118 operate to isolate the LNA 112 from the relatively high power transmission signal produced at the output of the PA 114, and also to prevent the PA 114 from being loaded by the LNA 112 and vice-versa.

More specifically, in transmit mode the control signal A applied to the gate (G) of switching FET 116 is such that the transistor is turned “off” (e.g. V_{G}=0V), and the control signal \overline{A} applied to the gate (G) of switching FET 118 is such that the transistor is turned “on” (e.g. V_{G}=+2.5V). Thus, in transmit mode the output of the PA 114 is electrically coupled to the antenna 150, while the LNA 112 is substantially isolated from the relatively high power transmission signal produced by the PA 114, and also does not undesirably load the PA 114. Conversely, in receive mode the control signal A applied to the gate (G) of switching FET 116 is such that the transistor is turned “on” (e.g. V_{G}=+2.5V), and the control signal A applied to the gate (G) of switching FET 118 is such that the transistor is turned “off” (e.g. V_{G}=0V). Thus, in receive mode the output of the PA 114 is isolated from the LNA 112 to prevent an undesired loading of the LNA 112 by the PA 114, while the LNA 112 is electrically coupled to the antenna 150.

A drawback of this monolithic transceiver 110 is that in transmit mode, the power level of the transmission signal may be sufficiently high to cause a breakdown and/or punch-through of the switching FET 116. For example, consider a transmitter producing a +30 dBm signal in a 100-ohm system. This signal translates to a peak voltage of 7 Volts across the FET 116. Under certain antenna mismatch conditions, this voltage can increase substantially. However, a 0.35 micron CMOS FET can only handle no more than 3.6 gate-to-source voltage (VGS). Accordingly, such power level of the transmitted signal would cause a breakdown and/or punch-through of the switching FET 116.

Other implementations have used PIN diodes as switches to isolate the receiver section from the transmitter section. However, integrating PIN diodes in a single RF integrated circuit is typically very complex.

### SUMMARY OF THE INVENTION

An aspect of the invention relates to a transceiver comprising a receiver, a transmitter, a first antenna port, a second antenna port, a first switching element to selectively couple the first antenna port to the receiver, a second switching element to selectively couple the second antenna port to the transmitter, and a third switching element to selectively couple the second antenna port to the receiver. In one embodiment, the third switching element may comprise a resonant switch which is configurable as a parallel resonant circuit in a first mode to desirably isolate the second antenna port from the receiver, and as a desirable coupling circuit in a second mode to couple the second antenna port to the receiver.

Another aspect of the invention relates to a method of receiving a signal. The method comprises directing a signal received from a first antenna port to a receiver while substantially isolating a second antenna port from the receiver. This signal receiving method may further comprise substantially isolating the receiver from a transmitter while the signal is being directed to the receiver.

Yet another aspect of the invention relates to a method of transmitting a signal. The method comprises directing a signal to a first antenna port from a transmitter while substantially isolating a receiver and a switching element from the transmitter. This signal transmitting method may further comprise substantially isolating the second antenna port from the receiver while the signal is being directed to the first antenna port.

Still another aspect of the invention relates to another method of receiving a signal. The method comprises directing a signal from a first antenna port to a receiver by way of a desirable coupling circuit while substantially isolating a second antenna port from the receiver. This signal receiving method may further comprise substantially isolating the first antenna port from a transmitter while the signal is being directed to the receiver.

Other aspects, features, and techniques of the invention will be apparent to one skilled in the relevant art in view of the following detailed description of the invention.

### BRIEF DESCRIPTION OF THE DRAWINGS

FIG. 1 illustrates a block diagram of an exemplary wireless transceiver system;

FIG. 2 illustrates a block diagram of an exemplary wireless transceiver system in accordance with an embodiment of the invention;

FIG. 3 illustrates a schematic diagram of an exemplary wireless transceiver system in accordance with another embodiment of the invention; and

FIG. 4 illustrates a schematic diagram of an exemplary wireless transceiver system in accordance with another embodiment of the invention.

### DETAILED DESCRIPTION OF THE INVENTION

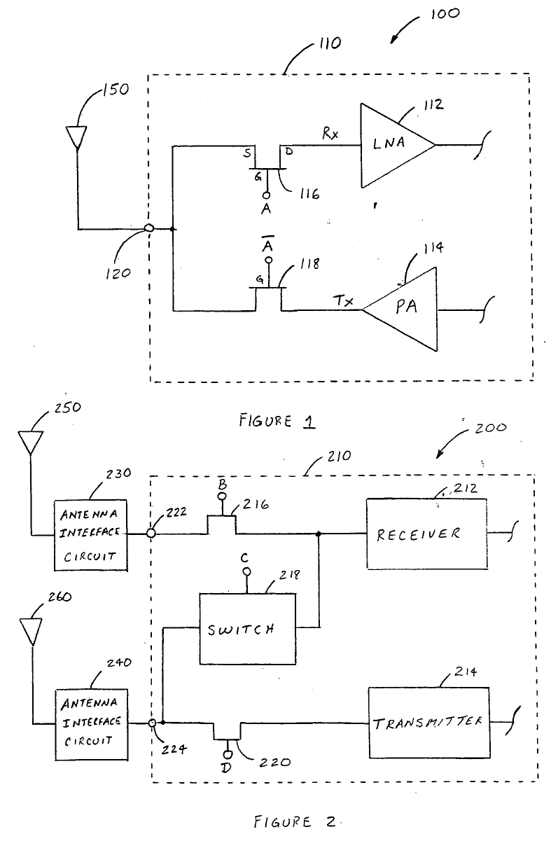

FIG. 2 illustrates a block diagram of an exemplary wireless transceiver system 200 in accordance with an embodiment of the invention. The wireless transceiver system 200 comprises a monolithic (integrated) transceiver 210 including a first antenna port 222 for coupling to a first antenna 250 by way of an antenna interface circuit 230, and a second antenna port 224 for coupling to a second antenna 260 by way of an antenna interface circuit 240. Each of the antenna interface circuits 230 and 240 may comprise a filter, balun, matching elements, and/or other components which desirably interface the integrated transceiver 210 to the corresponding antenna.

In this exemplary wireless transceiver system 200, the first antenna 250 may be used for primary signal reception. Whereas, the second antenna 260 may be used for both signal transmission and diversity signal reception. Other uses for the antennas 250 and 260 may be contemplated. In addition, although the transceiver 210 used to exemplify the invention is monolithic, it shall be understood that the transceiver 210 may be formed of only discrete elements or a combination of discrete and monolithic elements.

The monolithic transceiver 210, in turn, comprises a receiver section 212, a transmitter section 214, a first switching element 216 situated between the first antenna port 222 and the receiver section 212, a second switching element 220 situated between the second antenna port 224 and the transmitter section 214, and a third switching element 218 situated between the second antenna port 224 and the receiver section 212.

The receiver section 212 comprises elements to receive, amplify, and process a received signal. Accordingly, the receiver section 212 may take on many forms to accomplish these tasks. For example, the receiver section 212 may comprise a direct conversion type receiver, a heterodyne type receiver, or a super heterodyne type receiver. The particular configuration of the receiver section 212 is not critical to the invention.

The transmitter section 214 comprises elements to generate a radio frequency (RF) signal of sufficient power for transmission to another transceiver via a wireless medium. Accordingly, the transceiver section 214 may take on many forms to accomplish this task. For example, the transmitter section 214 may comprise may comprise a direct conversion type transmitter, a heterodyne type transmitter, or a super heterodyne type transmitter. The particular configuration of the transmitter section 214 is not critical to the invention.

Also, in the exemplary transceiver 210, the switching element 216 may comprise a field effect transistor (FET) including a channel between drain and source terminals situated between the first antenna port 222 and the receiver section 212, and a gate terminal to receive a signal B that controls the resistance of the channel. Similarly, the switching element 220 may also comprise a FET including a channel between drain and source terminals situated between the second antenna port 224 and the transmitter section 214, and a gate terminal to receive a signal D that controls the resistance of the channel. Although in this example the switching elements 216 and 220 are FETs, it shall be understood that other switching devices may be used. It shall be understood that the drain and source of each of the FETs 216 and 220 may be interchanged.

The switching element 218 may comprise a resonant switch which in one mode it operates as a desirable coupling circuit and in another mode it operates as a parallel resonant circuit. Responsive to a control signal C, the resonant switch 218 is configured either as a desirable coupling circuit or a parallel resonant circuit. For instance, in transmit mode, the control signal C is such that the resonant switch 218 is configured as a parallel resonant circuit. This causes the resonant switch 218 to exhibit a relatively high impedance to substantially isolate the receiver 212 and the switching element 216 from the relatively high power transmission signal produced by the transmitter section 214. In transmit mode, the switch 218 further functions to prevent an undesired loading of the transmitter section 214 by the receiver section 212. In diversity signal receive mode, the control signal C is such that the resonant switch 218 is configured as a desirable coupling circuit to direct the diversity signal from the second antenna port 224 to the receiver section 212.

In operation, during primary signal reception, the control signal B is such that FET 216 is turned “on” to substantially couple the antenna 250 to the receiver section 212; the control signal C is such that the resonant switch 218 is configured as a parallel resonant circuit to substantially isolate the receiver section 212 from the diversity antenna 260; and the control signal D is such that the FET 220 is turned “off” to substantially isolate the transmitter section 214 from the diversity antenna 260.

During diversity signal reception, the control signal B is such that FET 216 is turned “off” to substantially isolate the receiver section 212 from the primary antenna 250; the control signal C is such that the resonant switch 218 is configured as a desirable coupling circuit to couple the diversity antenna 260 to the receiver section 212; and the control signal D is such that the FET 220 is turned “off” to substantially isolate the transmitter section 214 from the diversity antenna 260 and to prevent the transmitter section 214 from loading the diversity antenna port 224.

During signal transmission, the control signal B is such that FET 216 is turned “off” to substantially isolate the receiver section 212 from the primary antenna 250; the control signal C is such that the resonant switch 218 is configured as a parallel resonant circuit to substantially isolate the receiver section 212 from the transmitter section 214 and to prevent the receiver from loading the diversity antenna port 224; and the control signal D is such that the FET 220 is turned “on” to substantially couple the transmitter section 214 to the antenna 260.

The exemplary transceiver 210 has several advantageous features. First, the reception of the primary signal is by way of a low loss switching element, namely FET 216. Second, the transmission of the output RF signal is also by way of a low loss switching element, namely FET 220. Third, the resonant switch 218 can effectively isolate the receiver 212 from the relatively high power transmission signal while the risk of damage due to break down or punch-through is relatively low. Although the resonant switch 218 may have a higher insertion loss than a FET, the gain associated with the diversity signal is typically 3 to 6 dB higher. Thus, the higher insertion loss of the resonant switch 218 is generally not a problem.

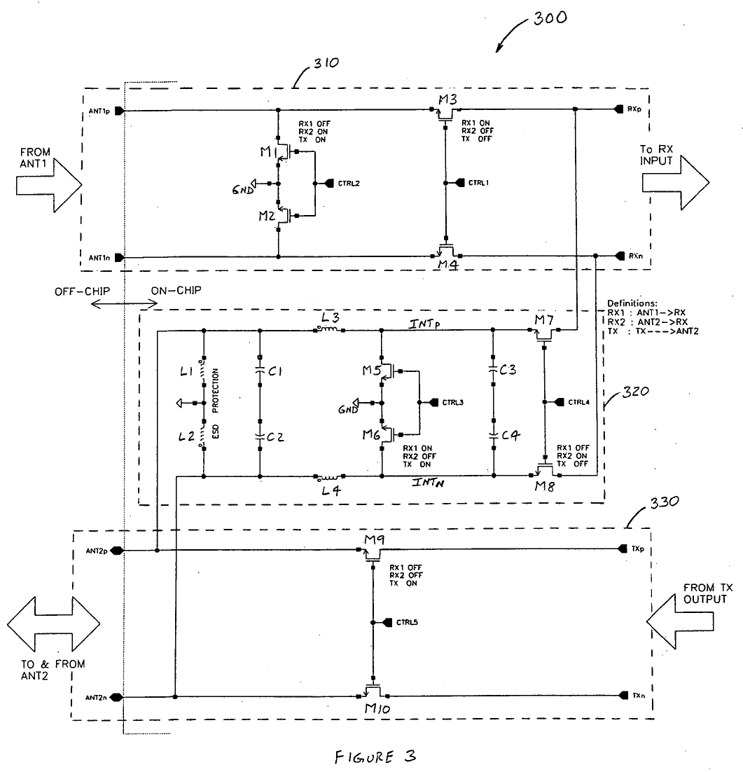

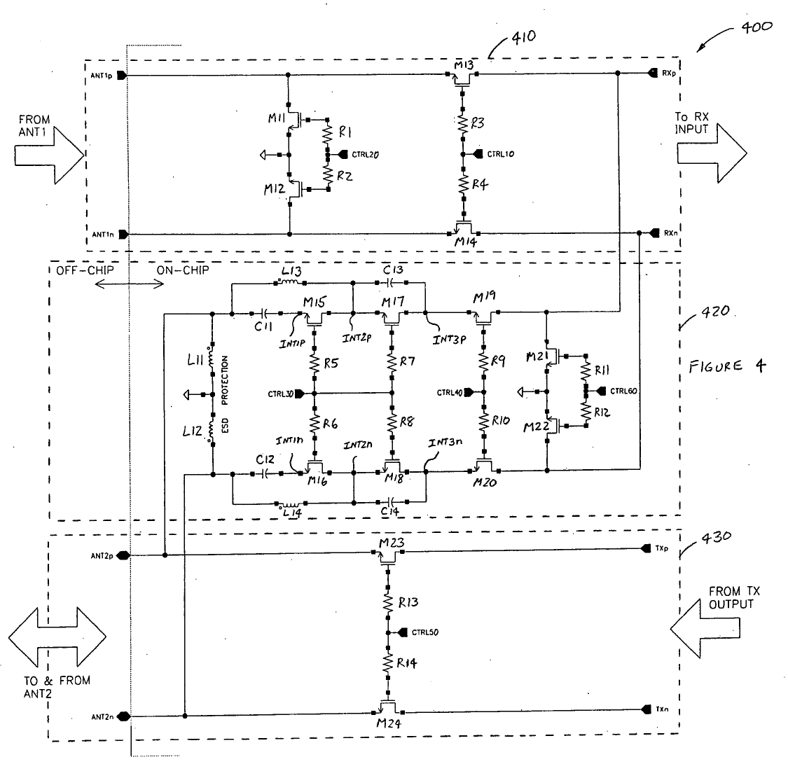

FIG. 3 illustrates a schematic diagram of an exemplary wireless transceiver system 300 in accordance with another embodiment of the invention. The wireless transceiver 300 may be formed on a monolithic substrate as shown, or as discrete elements, or as a combination of discrete elements and integrated elements. The wireless transceiver 300 comprises a first antenna receiving section 310 to receive signals from a first antenna ANT1, a second antenna receiving section 320 to receive signals from a second antenna ANT2, and a transmitting section 330 to transmit signals to the second antenna ANT2.

The first antenna receiving section 310, in turn, comprises positive and negative first antenna ports ANT1p and ANT1n for respectively coupling to the first antenna ANT1 by way of an antenna interface circuit, and positive and negative receiver ports RXp and RXn (shared with the second antenna receiving section 320) for respectively connecting to the positive and negative ports of a receiver (RX).

The first antenna receiving section 310 further comprises a pair of switching elements M1 and M2 for selectively connecting the positive and negative first antenna ports ANT1p and ANT1n to ground, respectively, in response to a control signal CTRL2. More specifically, the switching element M1 may comprise an n-channel FET having a drain terminal electrically connected to the positive first antenna port ANT1p, a gate terminal to receive the control signal CTRL2, and a source terminal electrically connected to ground. Similarly, the switching element M2 may comprise an n-channel FET having a drain terminal electrically connected to the negative first antenna port ANT1n, a gate terminal to receive the control signal CTRL2, and a source terminal electrically connected to ground. It shall be understood that the drain and source of each of the FETs M1-M2 may be interchanged.

The first antenna receiving section 310 further comprises another pair of switching elements M3 and M4 for selectively connecting the positive and negative first antenna ports ANT1p and ANT1n respectively to the positive and negative receiver ports RXp and RXn in response to a control signal CTRL1. More specifically, the switching element M3 may comprise an n-channel FET having a drain terminal electrically connected to the positive receiver port RXp, a gate terminal to receive the control signal CTRL1, and a source terminal electrically connected to the positive first antenna port ANT1p. Similarly, the switching element M4 may comprise an n-channel FET having a drain terminal electrically connected to the negative receiver port RXn, a gate terminal to receive the control signal CTRL1, and a source terminal electrically connected to the negative first antenna port ANT1n. It shall be understood that the drain and source of each of the FETs M3-M4 may be interchanged.

The second antenna receiving section 320, in turn, comprises positive and negative second antenna ports ANT2p and ANT2n (shared with the transmitter section 330) for respectively coupling to the second antenna ANT2 by way of an antenna interface circuit, and positive and negative receiver ports RXp and RXn (shared with the first antenna receiving section 310) for respectively connecting to the positive and negative ports of the receiver RX.

The second antenna receiving section 320, in turn, comprises an electrostatic discharge (ESD) protection section comprising a first inductor L1 electrically connected between the positive second antenna port ANT2p and ground, and a second inductor L2 electrically connected between the negative second antenna port ANT2n and ground. It shall be understood that inductors L1 and L2 can be replaced with a single or a plurality of inductors connected in series and/or in parallel. The second antenna receiving section 320 further comprises a pair of capacitors C1 and C2 connected in series between the positive and negative second antenna ports ANT2p and ANT2n. It shall be understood that capacitors C1 and C2 can be replaced with a single or a plurality of capacitors connected in series and/or in parallel.

In addition, the second antenna receiving section 320 comprises a pair of inductors L3 and L4 electrically connected between the positive and negative second antenna ports ANT2p and ANT2n and positive and negative intermediate nodes INTp and INTn. It shall be understood that inductors L3 and L4 can be replaced with a single or a plurality of inductors connected in series and/or in parallel. The second antenna receiving section 320 further comprises a pair of capacitors C3 and C4 connected in series between the positive and negative intermediate nodes INTp and INTn. It shall be understood that capacitors C3 and C4 can be replaced with a single or a plurality of capacitors connected in series and/or in parallel.

Also, the second antenna receiving section 320 comprises a pair of switching elements M5 and M6 for selectively connecting the positive and negative intermediate nodes INTp and INTn to ground, respectively, in response to a control signal CTRL3. More specifically, the switching element M5 may comprise an n-channel FET having a drain terminal electrically connected to the positive intermediate node INTp, a gate terminal to receive the control signal CTRL3, and a source terminal electrically connected to ground. Similarly, the switching element M6 may comprise an n-channel FET having a drain terminal electrically connected to the negative intermediate node INTn, a gate terminal to receive the control signal CTRL3, and a source terminal electrically connected to ground. It shall be understood that the drain and source of each of the FETs M5-M6 may be interchanged.

The second antenna receiving section 320 further comprises another pair of switching elements M7 and M8 for selectively connecting the positive and negative intermediate nodes INTp and INTn to the positive and negative receiver ports RXp and RXn, respectively, in response to a control signal CTRL4. More specifically, the switching element M7 may comprise an n-channel FET having a drain terminal electrically connected to the positive receiver port RXp, a gate terminal to receive the control signal CTRL4, and a source terminal electrically connected to the positive intermediate node INTp. Similarly, the switching element M8 may comprise an n-channel FET having a drain terminal electrically connected to the negative receiver port RXn, a gate terminal to receive the control signal CTRL4, and a source terminal electrically connected to the negative intermediate node INTn. It shall be understood that the drain and source of each of the FETs M7-M8 may be interchanged.

The transmitting section 330, in turn, comprises positive and negative second antenna ports ANT2p and ANT2n (shared with the second antenna receiving section 320) for respectively coupling to the second antenna ANT2 by way of an antenna interface circuit, and positive and negative transmitter ports TXp and TXn for respectively connecting to the positive and negative ports of a transmitter TX.

The transmitting section 330 further comprises a pair of switching elements M9 and M10 for selectively connecting the positive and negative second antenna ports ANT2p and ANT2n respectively to the positive and negative transmitter ports TXp and TXn in response to a control signal CTRL5. More specifically, the switching element M9 may comprise an n-channel FET having a drain terminal electrically connected to the positive transmitter port TXp, a gate terminal to receive the control signal CTRL5, and a source terminal electrically connected to the positive second antenna port ANT2p. Similarly, the switching element M10 may comprise an n-channel FET having a drain terminal electrically connected to the negative transmitter port TXn, a gate terminal to receive the control signal CTRL5, and a source terminal electrically connected to the negative second antenna port ANT2n. It shall be understood that the drain and source of each of the FETs M9-M10 may be interchanged.

In operation, in a first antenna receiving mode where a signal is to be received from the first antenna ANT1, the control signal CTRL1 is set to turn “on” switching elements M3 and M4 to electrically couple the positive and negative first antenna ports ANT1p and ANT1n respectively to the positive and negative receiver ports RXp and RXn. Also, the control signal CTRL 2 is set to turn “off” switching elements M1 and M2 to substantially isolate the positive and negative first antenna ports ANT1p and ANT1n (as well as the positive and negative receiver ports RXp and RXn) from ground potential. This configuration results in a relatively low insertion loss between the first antenna port ANT1 and the receiver RX.

Also in the first antenna receiving mode, the control signal CTRL 4 is set to turn “off” switching elements M7 and M8 to prevent an undesired loading of the receiver RX by the second antenna receiving section 320. In addition, the control signal CTRL 3 is set to turn “on” switching elements M5 and M6 to electrically couple the positive and negative intermediate nodes INTp and INTn to ground potential. This configuration sets up a parallel resonance circuit comprising capacitors C1 and C2 and inductors L3 and L4. The parallel resonance circuit results in a relatively high impedance level at the input of the second receiving antenna section 320, which substantially isolates the positive and negative receiver ports RXp and RXn from signals present at the positive and negative second antenna ports ANT2p and ANT2n.

Additionally, in the first antenna receiving mode, the control signal CTRL 5 is set to turn “off” switching elements M9 and M10 to substantially isolate the positive and negative transmitter ports TXp and TXn from the positive and negative second antenna ports ANT2p and ANT2n.

In the second antenna receiving mode where a signal is to be received from the second antenna ANT2, the control signal CTRL 4 is set to turn “on” switching elements M7 and M8 to electrically couple the positive and negative intermediate nodes INTp and INTn respectively to the positive and negative receiver ports RXp and RXn. In addition, the control signal CTRL 3 is set to turn “off” switching elements M5 and M6 to substantially isolate the positive and negative intermediate nodes INTp and INTn from ground potential. This configuration sets up a desirable coupling circuit comprising capacitors C1 and C2, inductors L3 and L4, and capacitors C3 and C4. The coupling circuit results in an impedance that is desirable for the reception of the signal from the second antenna ANT2.

Also in the second antenna receiving mode, the control signal CTRL1 is set to turn “off” switching elements M3 and M4 to prevent undesired loading of the receiver RX by the first antenna receiving section 310. Also, the control signal CTRL 2 is set to turn “on” switching elements M1 and M2 to electrically couple the positive and negative first antenna ports ANT1p and ANT1n to ground potential.

Additionally, in the second antenna receiving mode, the control signal CTRL 5 is set to turn “off” switching elements M9 and M10 to prevent an undesired loading of the second antenna port ANT2 by the transmitter TX.

In the transmitting mode where a signal is to be transmitted by way of the second antenna, the control signal CTRL 5 is set to turn “on” switching elements M9 and M10 to electrically couple the positive and negative transmitter ports TXp and TXn to the positive and negative second antenna ports ANT2p and ANT2n.

Also in the transmitting mode, the control signal CTRL 4 is set to turn “off” switching elements M7 and M8 to provide further isolation of the positive and negative receiver ports RXp and RXn from the positive and negative second antenna ports ANT2p and ANT2n. In addition, the control signal CTRL 3 is set to turn “on” switching elements M5 and M6 to electrically couple the positive and negative intermediate nodes INTp and INTn to ground potential. This configuration sets up a parallel resonance circuit comprising capacitors C1 and C2 and inductors L3 and L4. The parallel resonance circuit results in a relatively high impedance level at the input of the second receiving antenna section 320, which isolates the positive and negative receiver ports RXp and RXn from the transmitting signals present at the positive and negative second antenna ports ANT2p and ANT2n.

Also in the transmitting mode, the control signal CTRL1 is set to turn “off” switching elements M3 and M4 to substantially isolate the positive and negative receiver ports RXp and RXn respectively from the positive and negative first antenna ports ANT1p and ANT1n. Also, the control signal CTRL 2 is set to turn “on” switching elements M1 and M2 to electrically couple the positive and negative first antenna ports ANT1p and ANT1n to ground potential.

FIG. 4 illustrates a schematic diagram of an exemplary wireless transceiver system 400 in accordance with another embodiment of the invention. The wireless transceiver 400 may be formed on a monolithic substrate as shown, or as discrete elements, or as a combination of discrete elements and integrated elements. The wireless transceiver 400 comprises a first antenna receiving section 410 to receive signals from a first antenna ANT1, a second antenna receiving section 420 to receive signals from a second antenna ANT2, and a transmitting section 430 to transmit signals to the second antenna ANT2.

The first antenna receiving section 410, in turn, comprises positive and negative first antenna ports ANT1p and ANT1n for respectively coupling to the first antenna ANT1 by way of an antenna interface circuit, and positive and negative receiver ports RXp and RXn (shared with the second antenna receiving section 420) for respectively connecting to the positive and negative ports of a receiver (RX).

The first antenna receiving section 410 further comprises a pair of switching elements M11 and M12 for selectively connecting the positive and negative first antenna ports ANT1p and ANT1n to ground, respectively, in response to a control signal CTRL20. More specifically, the switching element M11 may comprise an n-channel FET having a drain terminal electrically connected to the positive first antenna port ANT1p, a gate terminal to receive the control signal CTRL20 by way of a bias resistor R1, and a source terminal electrically connected to ground. Similarly, the switching element M12 may comprise an n-channel FET having a drain terminal electrically connected to the negative first antenna port ANT in, a gate terminal to receive the control signal CTRL20 by way of a bias resistor R2, and a source terminal electrically connected to ground. It shall be understood that the drain and source of each of the FETs M11-M12 may be interchanged.

The first antenna receiving section 410 further comprises another pair of switching elements M13 and M14 for selectively connecting the positive and negative first antenna ports ANT1p and ANT1n respectively to the positive and negative receiver ports RXp and RXn in response to a control signal CTRL10. More specifically, the switching element M13 may comprise an n-channel FET having a drain terminal electrically connected to the positive receiver port RXp, a gate terminal to receive the control signal CTRL10 by way of a bias resistor R3, and a source terminal electrically connected to the positive first antenna port ANT1p. Similarly, the switching element M14 may comprise an n-channel FET having a drain terminal electrically connected to the negative receiver port RXn, a gate terminal to receive the control signal CTRL10 by way of a bias resistor R4, and a source terminal electrically connected to the negative first antenna port ANT1n. It shall be understood that the drain and source of each of the FETs M13-M14 may be interchanged.

The second antenna receiving section 420, in turn, comprises positive and negative second antenna ports ANT2p and ANT2n (shared with the transmitter section 430) for respectively coupling to the second antenna ANT2 by way of an antenna interface circuit, and positive and negative receiver ports RXp and RXn (shared with the first antenna receiving section 410) for respectively connecting to the positive and negative ports of the receiver RX.

The second antenna receiving section 420, in turn, comprises an electrostatic discharge (ESD) protection section comprising a first inductor L11 electrically connected between the positive second antenna port ANT2p and ground, and a second inductor L12 electrically connected between the negative second antenna port ANT2n and ground. It shall be understood that inductors L11 and L12 can be replaced with a single or a plurality of inductors connected in series and/or in parallel. The second antenna receiving section 420 further comprises a pair of capacitors C11 and C12 connected respectively between the positive and negative second antenna ports ANT2p and ANT2n and positive and negative first intermediate nodes INT1p and INT1n. It shall be understood that capacitors C11 and C12 can be replaced with a single or a plurality of capacitors connected in series and/or in parallel.

In addition, the second antenna receiving section 420 comprises a pair of inductors L13 and L14 electrically connected respectively between the positive and negative second antenna ports ANT2p and ANT2n and positive and negative second intermediate nodes INT2p and INT2n. It shall be understood that inductors L13 and L14 can be replaced with a single or a plurality of inductors connected in series and/or in parallel. The second antenna receiving section 420 further comprises a pair of capacitors C13 and C14 connected respectively between the positive and negative second intermediate nodes INT2p and INT2n and positive and negative third intermediate nodes INT3p and INT3n. It shall be understood that capacitors C13 and C14 can be replaced with a single or a plurality of capacitors connected in series and/or in parallel.

Also, the second antenna receiving section 420 comprises a pair of switching elements M15 and M16 for selectively connecting the capacitors C11 and C12 respectively to the positive and negative second intermediate nodes INT2p and INT2n in response to a control signal CTRL30. More specifically, the switching element M15 may comprise an n-channel FET having a source terminal electrically connected to the positive first intermediate node INT1p, a gate terminal to receive the control signal CTRL30 by way of a bias resistor R5, and a drain terminal electrically connected to the positive second intermediate node INT2p. Similarly, the switching element M16 may comprise an n-channel FET having a source terminal electrically connected to the negative first intermediate node INT1n, a gate terminal to receive the control signal CTRL30 by way of a bias resistor R6, and a drain terminal electrically connected to the negative second intermediate node INT2n. It shall be understood that the drain and source of each of the FETs M15-M16 may be interchanged.

The second antenna receiving section 420 further comprises another pair of switching elements M17 and M18 for selectively shorting out capacitors C13 and C14 and selectively coupling the positive and negative second intermediate nodes INT2p and INT2n to the positive and negative third intermediate nodes INT3p and INT3n, respectively, in response to a control signal CTRL30. More specifically, the switching element M17 may comprise an n-channel FET having a source terminal electrically connected to the positive second intermediate node INT2p, a gate terminal to receive the control signal CTRL30 by way of a bias resistor R7, and a drain terminal electrically connected to the positive third intermediate node INT3p. Similarly, the switching element M18 may comprise an n-channel FET having a source terminal electrically connected to the negative second intermediate node INT2n, a gate terminal to receive the control signal CTRL30 by way of a bias resistor R8, and a drain terminal electrically connected to the negative third intermediate node INT3n. It shall be understood that the drain and source of each of the FETs M17-M18 may be interchanged.

The second antenna receiving section 420 further comprises another pair of switching elements M19 and M20 for selectively coupling the positive and negative third intermediate nodes INT3p and INT3n respectively to the positive and negative receiver ports RXp and RXn in response to a control signal CTRL40. More specifically, the switching element M19 may comprise an n-channel FET having a source terminal electrically connected to the positive third intermediate node INT3p, a gate terminal to receive the control signal CTRL40 by way of a bias resistor R9, and a drain terminal electrically connected to the positive receiver port RXp. Similarly, the switching element M20 may comprise an n-channel FET having a source terminal electrically connected to the negative third intermediate node INT3n, a gate terminal to receive the control signal CTRL40 by way of a bias resistor R10, and a drain terminal electrically connected to the negative receiver port RXn. It shall be understood that the drain and source of each of the FETs M19-M20 may be interchanged.

The second antenna receiving section 420 further comprises another pair of switching elements M21 and M22 for selectively coupling the positive and negative receiver ports RXp and RXn to ground in response to a control signal CTRL60. More specifically, the switching element M21 may comprise an n-channel FET having a drain terminal electrically connected to the positive receiver port RXp, a gate terminal to receive the control signal CTRL60 by way of a bias resistor R11, and a source terminal electrically connected to ground. Similarly, the switching element M22 may comprise an n-channel FET having a drain terminal electrically connected to the negative receiver port RXn, a gate terminal to receive the control signal CTRL60 by way of a bias resistor R12, and a source terminal electrically connected to ground. It shall be understood that the drain and source of each of the FETs M21-M22 may be interchanged.

The transmitting section 430, in turn, comprises positive and negative second antenna ports ANT2p and ANT2n (shared with the second antenna receiving section 420) for respectively coupling to the second antenna ANT2 by way of an antenna interface circuit, and positive and negative transmitter ports TXp and TXn for respectively connecting to the positive and negative ports of a transmitter TX.

The transmitting section 430 further comprises a pair of switching elements M23 and M24 for selectively connecting the positive and negative second antenna ports ANT2p and ANT2n respectively to the positive and negative transmitter ports TXp and TXn in response to a control signal CTRL50. More specifically, the switching element M23 may comprise an n-channel FET having a drain terminal electrically connected to the positive transmitter port TXp, a gate terminal to receive the control signal CTRL50 by way of a bias resistor R13, and a source terminal electrically connected to the positive second antenna port ANT2p. Similarly, the switching element M24 may comprise an n-channel FET having a drain terminal electrically connected to the negative transmitter port TXn, a gate terminal to receive the control signal CTRL50 by way of a bias resistor R14, and a source terminal electrically connected to the negative second antenna port ANT2n. It shall be understood that the drain and source of each of the FETs M23-M24 may be interchanged.

In operation, in a first antenna receiving mode where a signal is to be received from the first antenna ANT1, the control signal CTRL10 is set to turn “on” switching elements M13 and M14 to electrically couple the positive and negative first antenna ports ANT1p and ANT1n respectively to the positive and negative receiver ports RXp and RXn. Also, the control signal CTRL 20 is set to turn “off” switching elements M11 and M12 to substantially isolate the positive and negative first antenna ports ANT1p and ANT1n (as well as the positive and negative receiver ports RXp and RXn) from ground potential. This configuration results in a relatively low insertion loss between the first antenna port ANT1 and the receiver RX.

Also in the first antenna receiving mode, the control signal CTRL 40 is set to turn “off” switching elements M19 and M20 to prevent an undesired loading of the receiver RX by the second antenna receiving section 420. Also, the control signal CTRL60 is set to turn “off” switching elements M21 and M22 to substantially isolate the positive and negative receiver ports RXp and RXn from ground potential. In addition, the control signal CTRL 30 is set to turn “on” switching elements M15 and M16 to place capacitors C11 and C12 respectively in parallel with inductors L13 and L14, and to turn “on” switching elements M17 and M18 to respectively short out capacitors C13 and C14. This configuration sets up a parallel resonance circuit comprising capacitors C11 and C12 respectively coupled in parallel with inductors L13 and L14. The parallel resonance circuit results in a relatively high impedance level at the input of the second receiving antenna section 420, which substantially isolates the positive and negative receiver ports RXp and RXn from signals present at the positive and negative second antenna ports ANT2p and ANT2n.

Additionally, in the first antenna receiving mode, the control signal CTRL 50 is set to turn “off” switching elements M23 and M24 to substantially isolate the positive and negative transmitter ports TXp and TXn from the positive and negative second antenna ports ANT2p and ANT2n.

In the second antenna receiving mode where a signal is to be received from the second antenna ANT2, the control signal CTRL 40 is set to turn “on” switching elements M19 and M20 to electrically couple the positive and negative third intermediate nodes INT3p and INT3n respectively to the positive and negative receiver ports RXp and RXn. Also, the control signal CTRL60 is set to turn “off” switching elements M21 and M22 to substantially isolate the positive and negative receiver ports RXp and RXn from ground potential. In addition, the control signal CTRL 30 is set to turn “off” switching elements M15, M16, M17, and M18 to electrically couple the positive and negative second antenna ports ANT2p and ANT2n respectively to the positive and negative receiver ports RXp and RXn respectively by way of inductors L13 in series with capacitor C13, and inductor L14 in series with capacitor C14. This configuration sets up a desirable coupling circuit comprising capacitor L13 connected in series with capacitor C13, and inductor L14 connected in series with capacitor C14. The coupling circuit results in an impedance that is desirable for the reception of the signal from the second antenna ANT2.

Also in the second antenna receiving mode, the control signal CTRL10 is set to turn “off” switching elements M13 and M14 to prevent undesired loading of the receiver RX by the first antenna receiving section 410. Also, the control signal CTRL 20 is set to turn “on” switching elements M11 and M12 to electrically couple the positive and negative first antenna ports ANT1p and ANT1n to ground potential.

Additionally, in the second antenna receiving mode, the control signal CTRL 50 is set to turn “off” switching elements M23 and M24 to prevent an undesired loading of the second antenna port ANT2 by the transmitter TX.

In the transmitting mode where a signal is to be transmitted by way of the second antenna, the control signal CTRL 50 is set to turn “on” switching elements M23 and M24 to electrically couple the positive and negative transmitter ports TXp and TXn to the positive and negative second antenna ports ANT2p and ANT2n.

Also in the transmitting mode, the control signal CTRL 40 is set to turn “on” switching elements M19 and M20 to electrically couple the positive and negative third intermediate nodes INT3p and INT3n respectively to the positive and negative receiver ports RXp and RXn. Also, the control signal CTRL 60 is set to turn “on” switching elements M21 and M22 to ground the positive and negative receiver ports RXp and RXn, thereby providing further isolation of the positive and negative receiver ports RXp and RXn from the positive and negative transmitter ports TXp and TXn. In addition, the control signal CTRL 30 is set to turn “on” switching elements M15 and M16 to place capacitors C11 and C12 respectively in parallel with inductors L13 and L14, and to turn “on” switching elements M17 and M18 to respectively short out capacitors C13 and C14. This configuration sets up a parallel resonance circuit comprising capacitors C11 and C12 respectively coupled in parallel with inductors L13 and L14. The parallel resonance circuit results in a relatively high impedance level at the input of the second receiving antenna section 420, which substantially isolates the positive and negative receiver ports RXp and RXn from transmission signals present at the positive and negative second antenna ports ANT2p and ANT2n.

Also in the transmitting mode, the control signal CTRL10 is set to turn “off” switching elements M13 and M14 to substantially isolate the positive and negative receiver ports RXp and RXn respectively from the positive and negative first antenna ports ANT1p and ANT1n. Also, the control signal CTRL 20 is set to turn “on” switching elements M11 and M12 to electrically couple the positive and negative first antenna ports ANT1p and ANT1n to ground potential.

The transceivers 200, 300, and 400 described herein can be used in many applications where time division duplex (TDD) is used as the mode of communication. In TDD, a transceiver is either transmitting or receiving at a particular instance of time. Such applications using TDD includes wireless local area networks (WLAN), mobile telephones, and other applications.

While the invention has been described in connection with various embodiments, it shall be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A transceiver, comprising:
a receiver;
a transmitter;
a first antenna port;
a second antenna port;
a first switching element to selectively couple said first antenna port to said receiver;
a second switching element to selectively couple said second antenna port to said transmitter; and
a third switching element to selectively couple said second antenna port to said receiver.

2. The transceiver of claim 1, wherein said third switching element comprises a resonant switch which is configurable as a parallel resonant circuit in a first mode to substantially isolate said second antenna port from said receiver, and configurable as a coupling circuit in a second mode to substantially couple said second antenna port to said receiver.

3. The transceiver of claim 1, wherein said receiver comprises a direct conversion receiver, a heterodyne receiver or a super heterodyne receiver.

4. The transceiver of claim 1, wherein said transmitter comprises a direct conversion transmitter, a heterodyne transmitter or a super heterodyne transmitter.

5. The transceiver of claim 1, wherein said first switching element comprises a transistor.

6. The transceiver of claim 5, wherein said transistor comprises a field effect transistor.

7. The transceiver of claim 1, wherein said second switching element comprises a transistor.

8. The transceiver of claim 7, wherein said transistor comprises a field effect transistor.

9. The transceiver of claim 2, wherein said resonant circuit comprises:
a first capacitive element;
a second capacitive element;
a series inductive element coupled to said first capacitive element at a first node, and to said second capacitive element at a second node;
a fourth switching element to selectively couple said second node to ground potential; and
a fifth switching element to selectively couple said second node to said receiver.

10. The transceiver of claim 9, wherein said first capacitive element comprises a capacitor.

11. The transceiver of claim 9, wherein said second capacitive element comprises a capacitor.

12. The transceiver of claim 9, wherein said fourth switching element comprises a transistor.

13. The transceiver of claim 12, wherein said transistor comprises a field effect transistor.

14. The transceiver of claim 9, wherein said fifth switching element comprises a transistor.

15. The transceiver of claim 14, wherein said transistor comprises a field effect transistor.

16. The transceiver of claim 2, wherein said resonant circuit comprises:
a first capacitive element;
a second capacitive element;
an inductive element coupled to said first capacitive element at a first node, and to said second capacitive element at a second node;
a fourth switching element to selectively couple said first capacitive element to said second node;
a fifth switching element to selectively short out said second capacitive element, wherein said fifth switching element is electrically connected between said second node and a third node; and
a sixth switching element to selectively couple said third node to said receiver.

17. The transceiver of claim 16, further comprising a seventh switching element to selectively couple said receiver to ground potential.

18. The transceiver of claim 1, wherein said transceiver is configured as a monolithic transceiver.

19. The transceiver of claim 1, further comprising:
a first antenna coupled to said first antenna port; and
a second antenna coupled to said second antenna port.

20. The transceiver of claim 1, further comprising an electrostatic discharge (ESD) protection circuit coupled to said second antenna port.

21. The transceiver of claim 20, wherein said ESD protection circuit comprises an inductive element.

22. A method of receiving a signal comprising directing said signal received from a first antenna port to a receiver while substantially isolating a second antenna port from said receiver using a parallel resonant circuit.

23. The method of claim 22, further comprising substantially isolating said second antenna port from a transmitter while said signal is being directed to said receiver.

24. A method of transmitting a signal comprising directing said signal to a first antenna port from a transmitter while substantially isolating a receiver and a switching element using a parallel resonant circuit, wherein said switching element selectively couples said receiver to a second antenna port.

25. The method of claim 24, further comprising substantially isolating said second antenna port from said receiver while said signal is being directed to said first antenna port.

26. A method of receiving a signal comprising directing said signal from a first antenna port to a receiver by way of a coupling circuit while substantially isolating a second antenna port from said receiver.

27. The method of claim 26, further comprising substantially isolating said first antenna port from a transmitter while said signal is being directed to said receiver.
